(19) United States
(12) Patent Application Publication
(10) Pub. No.: US 2021/0276191 A1
(43) Pub. Date: Sep. 9, 2021

(54) Method and Safety Oriented Control Device for Determining and/or Selecting a Safe Condition

(71) Applicant: Siemens Aktiengesellschaft, Muenchen (DE)

(72) Inventor: Frank Dittrich SCHILLER, Nürnberg (DE)

(21) Appl. No.: 17/190,639

(22) Filed: Mar. 3, 2021

(30) Foreign Application Priority Data
Mar. 4, 2020 (EP) 20160949

(51) Int. Cl. B25J 9/16; G06F 13/40; G06N 3/08

(52) U.S. Cl. CPC B25J 9/1674; G06F 13/409; G06N 3/08; B25J 9/161; B25J 9/163

(57) ABSTRACT

A method and safety-oriented control device for determining and/or selecting a safe condition using a safety-oriented control device configured for safety-oriented control of an apparatus or installation via execution of a safety-oriented control program which, when executed, results in a safe reaction being triggered in the safety-oriented controller, wherein the method is implemented such that an ML model is configured and formed as a result, which is stored in a memory device, of the application of a machine learning method, such that data relevant to the determination of a safe condition are stored in connection with the triggering of the safe reaction, and such that a first safe condition is determined via the data relevant to the determination of the safe condition being applied to the ML model.

### BACKGROUND OF THE INVENTION

### 1. Field of the Invention

The present invention relates to a method for determining a safe condition by using a safety-oriented control device and an appropriately configured safety-oriented controller, where the safety-oriented control device is configured for the safety-oriented control of an apparatus or installation via execution of a safety-oriented control program, and where the execution of the safety-oriented control program results in a safe reaction being triggered in the safety-oriented controller.

### 2. Description of the Related Art

U.S. Pat. No. 9,823,959 B2 discloses a microcontroller unit designed and configured for operation of applications for providing functional safety. Here, the microcontroller unit has a reset condition as a safe condition in order to be able to react to applicable sources of error. Optionally, the microcontroller unit can also have multiple safe conditions. In U.S. Pat. No. 9,823,959 B2, it is possible for sources of error to be, for example, an incorrect temperature or an overvoltage, which then trigger the resetting of the microcontroller unit to the reset condition.

There is often precisely one safe condition that is adopted in a safety-critical situation (e.g., stoppage of the production installation or opening of a valve). Recently, a set of safe conditions that can be adopted depending on different operating parameters has been defined increasingly more often on an application-specific basis. Each of these conditions prevents the danger in the safety-critical situation under consideration.

A disadvantage of the prior art is that a person skilled in the art is provided with no kind of indication as to how a safe condition is selected for the purposes of functional safety. Therefore, as soon as a precisely predefined safe condition is not firmly prescribed, or if not just one precisely predefined safe condition is prescribed, for example, a person skilled in the art has no information at all regarding how he can select the safe condition in an error situation for the purposes of functional safety, or else how a system is best put into a firmly prescribed safe condition.

### SUMMARY OF THE INVENTION

It is therefore an object of the present invention to provide a method for ascertaining and/or selecting a safe condition for the purposes of functional safety.

This and other objects and advantages are achieved in accordance with the invention by a method which a safe condition is determined by using a safety-oriented control device, where the safety-oriented control device is configured for the safety-oriented control of an apparatus or installation via the execution of a safety-oriented control program, and where the execution of the safety-oriented control program results in a safe reaction being triggered in the safety-oriented controller.

In accordance with the method of the invention, an ML model is provided, where the ML model is configured as and forms a result, which is stored in a memory device, of the application of a machine learning method.

In connection with the triggering of the safe reaction, data relevant to the determination of a safe condition are then stored, after which a first safe condition is determined via the data relevant to the determination a safe condition being applied to the ML model.

The method can moreover be established such that the machine or installation is put into the first safe condition by the safety-oriented control device subsequently to the determination of the first safe condition.

Quite generally, three aspects of system safety can be considered with reference to safety in a machine, installation and/or production setting.

A first aspect is “primary safety”, which concerns risks such as electrocution and combustion, which are caused directly by the hardware.

A second aspect is “functional safety”, which covers the safety of devices (known as “EUC”—see below), where this functional safety is dependent on the relevant measures for mitigating risk and hence being related to the correct operation of these measures.

A third aspect is indirect safety, which concerns the indirect consequences of incorrect operation of a system, such as the production of incorrect information by an information system such as a medical database.

The International Electrotechnical Commission (IEC) standard 61508 (IEC 61508) essentially concerns the second of these aspects, namely functional safety. It is certainly possible for the principles used therein to be applicable generally too, however.

In the field of safety when handling or controlling machines and installations, there are moreover three particularly noteworthy, sector-specific standards that may be relevant in addition to IEC 61508. The German standard DIN 19250 entitled “Fundamental safety considerations for MSR protection equipment” was developed even before the first drafts of the international standard, and its content was used therein. The US standard S84 was developed at the same time as the precursor to IEC 61508, and it was established in accordance with the principles thereof. Moreover, the international standard IEC 61511 was developed on the basis of IEC 61508 in order to allow a genuine sector-specific interpretation for the processing industry.

The following constitute a few definitions that are worded in line with part 4 of IEC 61508, and are used for the purposes of the present disclosure. The terms selected for the definition are those deemed most important to the readers of this document.

“Equipment under control” (“EUC”): equipment, machines, devices or installations that are used for manufacturing, processing, transport, medical or other activities.

“EUC control system”: system that reacts to input signals from the process and/or from a user and generates output signals that cause the EUC to operate in the desired manner.

“Programmable electronic system (PES)” or “electrical/electronic/programmable electronic system (E/E/PE)”: in each case a system for controlling, protecting or monitoring based on one or more programmable electronic apparatuses, including all elements of the system, such as power supplies, sensors and other input apparatuses, data highways and other communication channels and also actuating elements and other output apparatuses.

“Safety”: freedom from unacceptable risk.

“Safe condition”: condition of a machine or installation in which there is no unacceptable risk from the apparatus or installation.

“Safety-related system”: a system that (i) implements the requisite safety functions needed in order to achieve or maintain a safe condition for the EUC; and (ii) is intended to achieve the requisite safety integrity for the requisite safety functions on its own or with other safety-relevant E/E/PE systems, other safety-relevant technologies or external devices for mitigating risk.

“Functional safety”: part of the overall safety in connection with the EUC and the EUC control system, dependent on the correct operation of the safety-relevant systems E/E/PE, other safety-relevant systems in the technology and external devices for mitigating risk.

“Safety function”: function that needs to be performed by a safety-related E/E/PE system, another safety-related technology system or external risk mitigation devices that are supposed to achieve or maintain a safe condition for the EUC with reference to a specific dangerous event.

“Safety integrity”: likelihood of a safety-related system satisfactorily performing the requisite safety functions under all specified circumstances within a specific period.

“Software safety integrity”: measures ensuring that the software of a programmable electronic system achieves the appropriate safety functions under all stipulated circumstances within a stipulated time.

“Hardware safety integrity”: part of the safety integrity of safety-related systems that relate to random hardware errors in a dangerous condition.

“Safety integrity level (SIL)”: discrete level (one of four possible levels) for stipulating the safety integrity requirements for the safety functions that need to be assigned to the safety-related E/E/PE systems, with SIL 4 being the highest level of safety integrity and SIL 1 being the lowest level of safety integrity.

“Specification of the safety requisites”: specification that contains all requisites in reference to safety functions that a safety-oriented system needs to perform.

“Specification of the requirements for safety functions”: specification containing the requirements for the safety functions that need to be performed by the safety-related systems. [A part of the safety requirement specifications].

“Specification of the safety integrity requirements”: specification containing the requirements for the safety integrity of the safety functions that need to be performed by the safety-related systems. This is integrated in the specification of the safety requirements.

A safety-oriented control device can be configured such that it can be guaranteed that a dangerous condition cannot arise during the operation of the safety-oriented control device, for example, as a result of failure of a component. A safety-oriented control device can moreover be configured such that an unacceptable risk cannot arise during the operation of the safety-oriented control device as a result of an apparatus or installation controlled thereby, or at least inter alia thereby.

Some or all of the mechanisms listed below, for example, can be implemented in a safety-oriented control device for the purposes of a software and/or hardware safety integrity: (i) for the purpose of detecting random errors, self-tests are continually performed in the safety-oriented control device that involve checking for example the availability of a central assembly, of input/output cards, of interfaces and of peripherals; (ii) the hardware can be of redundant design in order to be able to detect errors in the hardware or during the execution of the control program; (iii) there can be provision for “coded processing” during the execution of a control program in order to be able to detect errors in the execution of the control program; (iv) double compilation of the control program and comparison of the generated machine codes render errors detectable in the case of discrepancies; (v) the data are stored in the redundant memory units (RAM, EPROM, . . . ) directly and inversely and are checked for inequality by a hardware comparator; and (v) additional test and monitoring functions can be performed, such as monitoring of the mains voltage, test on the central processing units for the writability of flags, addressability or register overflow, tests on the input channels, tests on the output channels, tests on the data transmission via an internal bus.

In particular, a safety-oriented control device can be configured in compliance with at least one of the standards IEC 61508, DIN 19520 or IEC 61511.

The safety-oriented control device can be formed and configured as a programmable logic controller (PLC), for example. Moreover, the safety-oriented control device can also be configured and formed as a modular programmable logic controller (modular PLC).

The safety-oriented control device can moreover also be formed and configured as an “EDGE device”, such an EDGE device being able to comprise, for example, an application for controlling apparatuses or installations, in particular for controlling the apparatus or installation. For example, such an application can be formed and configured as an application having the functionality of a programmable logic controller. The EDGE device can, for example, moreover be connected to a control device of a safety-oriented installation or otherwise directly to the safety-oriented installation, an apparatus or installation to be controlled or the controlled apparatus or installation. Moreover, the EDGE device can be configured such that it is additionally also connected to a data network or a cloud, or is configured for connection to an applicable data network or an applicable cloud.

A safety-oriented control program can be configured such that it is assured that a dangerous condition cannot arise during the execution of the safety-oriented control program for the purposes of controlling the apparatus or installation, for example, as a result of failure of a component. A safety-oriented control program can be configured such that an unacceptable risk cannot arise during the execution of the safety-oriented control program for the purposes of controlling the apparatus or installation as a result of the apparatus or installation.

In particular, a safety-oriented control program can be designed and configured in compliance with at least one of the standards IEC 61508, DIN 19520 or IEC 61511.

The first safe condition, and quite generally any safe condition, can be, for example, a condition stipulated by defined apparatus or installation parameters. Moreover, the first safe condition or a safe condition quite generally, can also be formed and configured as a safe condition in accordance with the standard IEC 61508, DIN 19520 and/or IEC 61511, for example.

Defined apparatus or installation parameters of this kind can comprise, e.g., specific single values for such apparatus or installation parameters or appropriate combinations thereof. Moreover, the defined apparatus or installation parameters can also comprise value ranges for specific machine or installation parameters.

There may also be multiple safe conditions defined or prescribed for an apparatus or installation, or a safety-oriented system, where each of the safe conditions can be configured in accordance with the present disclosed embodiments of the invention.

Safe conditions can exist, for example, as a result of the switching-off, stopping and/or disconnection of an apparatus or installation. Moreover, safe conditions can exist, for example, as a result of a specific position or orientation of a machine or installation, or of respective parts thereof. Safe conditions can also exist, for example, as a result of a shutdown or a specific speed of the apparatus or installation or parts thereof.

Value ranges for apparatus or installation parameters can be, for example, parameter ranges that lead to a specific position or orientation range for the apparatus or installation, or respective parts thereof. Accordingly, value ranges for apparatus or installation parameters can be, for example, parameter ranges that lead to a specific speed range for the apparatus or installation, or respective parts thereof.

A safe condition, or the first safe condition, can also exist as a result of a succession of parameter values. As such, the succession of parameter values can be configured, for example, such that the apparatus or installation or respective parts or components thereof successively adopt(s) operating conditions corresponding to the respective parameter values in accordance with the succession of parameter values. In this way, the safe condition can also be defined as a succession of conditions that ultimately lead to safe arrival at a safe final condition.

The apparatus or installation can be, for example, formed and configured as a machine, a device, a robot, a production installation or similar or else can comprise such parts as components. Such an apparatus or installation can comprise, e.g., one or more components, drives, sensors, machines, devices or communication devices.

An ML model can quite generally be formed and configured as, e.g., a result, which is stored in a memory device, of the application of a machine learning method to specific training data, in particular ML training data, in accordance with the presently disclosed embodiments.

The safety-oriented control device can comprise the memory device. Moreover, the memory device can also be communicatively coupled to the safety-oriented control device.

A machine learning method is understood to mean, for example, an automated (“machine”) method that does not generate results by using rules stipulated in advance but rather involves regularities being (automatically) identified from multiple or otherwise many examples via a machine learning algorithm or learning method and then being taken as a basis for producing statements about data that need to be analyzed.

Such machine learning methods can be, for example, formed and configured as a supervised learning method, a partially supervised learning method, an unsupervised learning method or otherwise a reinforcement learning method.

Examples of machine learning methods are, e.g., regression algorithms (e.g., linear regression algorithms), production or optimization of decision trees, learning methods for neural networks, clustering methods (e.g., “k-means clustering”), learning methods for or production of support vector machines (SVMs), learning methods for or production of sequential decision models or learning methods for or production of Bayesian models or networks.

The result of such an application of such a machine learning algorithm or learning method to specific data is referred to, in particular in the present disclosure, as a “machine learning” model or ML model. Such an ML model is the digitally stored or storable result of the application of a machine learning algorithm or learning method to analyzed data.

The production of the ML model can be established such that the ML model is formed anew by the application of the machine learning method or an already existing ML model is altered or adapted by the application of the machine learning method. Examples of such ML models are results of regression algorithms (e.g., of a linear regression algorithm), neural networks, decision trees, the results of clustering methods (including, e.g., the clusters or cluster categories, cluster definitions and/or cluster parameters obtained), support vector machines (SVMs), sequential decision models or Bayesian models or networks.

Neural networks can be, e.g., “deep neural networks”, “feedforward neural networks”, “recurrent neural networks”; “convolutional neural networks” or “autoencoder neural networks”. The application of appropriate machine learning methods to neural networks is frequently also referred to as “training” of the applicable neural network.

Decision trees can be formed and configured, for example, as an “iterative dichotomizer 3” (ID3), classification and regression trees (CARTs) or “random forests”.

ML training data for training the ML model can be, for example, recorded or stored data that were or are each characteristic of the triggering of a safe reaction. Moreover, such ML training data can also be recorded or stored data that were or are relevant to the determining of a safe condition for the purposes of functional safety.

Such ML training data for training the ML model can be, e.g., historical control data in reference to the apparatus or installation. In particular, such historical control data can be control data labeled in reference to safety-oriented incidents.

Such historical control data can be, e.g., values recorded in the past for one or more variables of the safety-oriented control program, or can comprise such data. Moreover, such historical control data can also be values recorded in the past for a process image of a safety-oriented programmable logic controller that were available in the process image for the purposes of safety-oriented control of the apparatus or installation, or can comprise such data.

The labeling or description of the historical control data can be specified, for example, such that historical control data that had led to a safety-oriented incident are assigned a safe condition and/or a succession of safe conditions such that, e.g., as little financial loss as possible arises as a result of the occurrence of the safety-oriented incident.

As such, depending on the safety-oriented incident that occurs, an apparatus or installation shutdown can be triggered (e.g., if there is a person in a dangerous area) or otherwise an operating speed can just be reduced (e.g., if a specific component is at an increased temperature), for example.

Moreover, ML training data can also be determined and/or stored for the purposes of the safety-oriented control of the apparatus or installation. For example, variables, sensor values, control quantities, parameter values and/or similar values can be stored for the purposes of the triggering of a safe reaction. Moreover, this can be accomplished by virtue of an identifier for the error situation that has arisen and/or information pertaining to a preferred safe condition, or a preferred succession of safe conditions, being stored. The ML model can then subsequently be trained by using these stored data.

Here, the safe condition, or the succession of safe conditions, can also be selected such that as little financial loss as possible arises as a result of the occurrence of the safety-oriented incident.

A neural network is understood, at least in connection with the present disclosed embodiments, to mean an electronic device that comprises a network of “nodes”, where each node is normally connected to multiple other nodes. The nodes are also referred to as neurons or units, for example. Each node has at least one input connection and one output connection. Input nodes for a neural network are understood to mean nodes that can receive signals (data, stimuli, or patterns) from the outside world. Output nodes of a neural network are understood to mean nodes that can forward signals, data or the like to the outside world. So-called “hidden nodes” are moreover understood to mean nodes of a neural network that are neither in the form of input nodes nor in the form of output nodes.

The neural network in this case can be formed as a deep neural network (DNN), for example. Such a “deep neural network” is a neural network in which the network nodes are arranged in layers (the layers themselves being able to be one-dimensional, two-dimensional or otherwise of higher dimensionality). A deep neural network comprises at least one or two hidden layers, which comprise only nodes that are not input nodes or output nodes. That is, the hidden layers have no connections for input signals or output signals.

So-called “deep learning” is understood to mean, for example, a class of machine learning techniques or learning methods that utilizes multiple or else many layers of the nonlinear information-processing for supervised or unsupervised feature extraction and transformation and for pattern analysis and classification.

The neural network can, for example, moreover (or additionally) also have an autoencoder structure, which will be explained in more detail in the course of the present disclosure. Such an autoencoder structure can be suitable, for example, for reducing a dimensionality of the data and, for example, for thus detecting similarities and commonalities within the framework of the supplied data.

A neural network can, for example, also be formed as a “classification network”, which is particularly suitable for putting data into categories. Such classification networks are used in connection with handwriting recognition, for example.

A further possible structure of a neural network can be, for example, an embodiment comprising a “deep belief network”.

A neural network can, for example, also have a combination of several of the structures cited above. As such, for example, the architecture of the neural network can have an autoencoder structure in order to reduce the dimensionality of the input data, where the autoencoder structure can then moreover be combined with another network structure, for example, in order to detect peculiarities and/or anomalies within the reduced-data dimensionality, or to classify the reduced-data dimensionality.

The values describing the individual nodes and the connections thereof, including further values describing a specific neural network, can be stored in a memory device in a value set describing the neural network, for example. Such a stored value set, or else the memory device containing the stored value set, is then an embodiment of the neural network, for example. If such a value set is stored after a training of the neural network, this means that an embodiment of a trained neural network is stored, for example. As such, it is possible, for example, to train the neural network with appropriate training data, the applicable value set assigned to this neural network, in a first computer system, then to store the neural network and transfer it as an embodiment of the trained neural network to a second system.

A neural network can normally be trained by using a wide variety of known learning methods to determine parameter values for the individual nodes or for the connections thereof by inputting input data into the neural network and analyzing the then corresponding output data from the neural network. This allows a neural network to be trained with known data, patterns, stimuli or signals in a manner that is known per se in order to be then able to use the thus trained network subsequently for the purpose of analyzing further data, for example.

The training of the neural network is generally understood to mean that the data with which the neural network is trained are processed in the neural network via training algorithms to calculate or alter bias values (“bias”), weighting values (“weights”) and/or transfer functions of the individual nodes of the neural network or of the connections between two respective nodes within the neural network.

Training of a neural network, e.g., in accordance with the disclosed embodiments of the present invention, can be accomplished, for example, by using one of the “supervised learning” methods. These involve training with applicable training data each being used to train a network with results or capabilities assigned to these data. Moreover, training of the neural network can also be accomplished by using an unsupervised training method (“unsupervised learning”). For a given set of inputs, such an algorithm produces, for example, a model that describes the inputs and allows predictions therefrom. There are, for example, clustering methods that can be used to put the data into different categories if they differ from one another by virtue of characteristic patterns, for example.

The training of a neural network can also involve supervised and unsupervised learning methods being combined, for example, if parts of the data have associated trainable properties or capabilities, while this is not the case for another part of the data.

Moreover, it is also possible to use reinforcement learning methods for training the neural network, at least inter alia.

For example, training that demands a relatively high level of processing power from an applicable computer can occur on a high-performance system, while other work or data analyses using the trained neural network can then certainly be performed on a lower-performance system. Such further work and/or data analyses using the trained neural network can be effected, for example, on an assistance system and/or on a control device, an EDGE device, a programmable logic controller or a modular programmable logic controller or other appropriate devices in accordance with the disclosed embodiments of the invention.

The triggering of a safe reaction can be understood to mean, for example, the triggering of a safety function of a safety-oriented system as defined by the standard IEC 61508.

Such triggering of a safe reaction can be achieved, for example, by virtue of specific measured sensor values exceeding specific limit values prescribed in the safety-oriented system. Moreover, the adoption of a specific prescribed sensor value can also trigger an applicable safe reaction. Examples of such sensor values can be, for example, the sensor value of a light barrier or of a contact switch or else can be measured values for specific temperatures, measured pollutant concentrations, specific acoustic information, brightness values or similar sensor values. Applicable sensors can be, for example, any kind of light or contact sensors, chemical sensors, temperature sensors, a wide variety of cameras or comparable sensors.

Moreover, the triggering of a safe reaction during safety-oriented control can also be achieved, for example, by virtue of specific variables used for the purposes of the safety-oriented control adopting predetermined values or exceeding and/or undershooting specific limit values. Such variables can be, for example, variables that are stored in a process image of a programmable logic controller and/or are used during the execution of a safety-oriented control program. Moreover, such variables can also be, for example, flags or tags, which can be used for the purposes of controlling a system or an associated supervisory control and data acquisition/operating and observation (SCADA) system.

The memory device and/or the module memory device can be formed and configured as an electronic memory device, or digital memory device.

Such a memory device can be, for example, formed as a nonvolatile data memory that is configured for permanent or longer-term data storage. Such memory devices can be, for example, formed as SSD memories, SSD cards, hard disks, CDs, DVDs, EPROMs or flash memories or comparable memory devices.

Moreover, a memory device can also be formed and configured as volatile memory. Such memories can be, for example, formed and configured as DRAM or dynamic RAM (“dynamic random access memory”) or SRAM (“static random access memory”).

A memory device with an ML model stored therein can also be, for example, formed and configured as an integrated circuit in which the ML model, at least inter alia, is implemented.

Data relevant to the determination of a safe condition can be, for example, data as are also used or can also be used for triggering a safe reaction. Moreover, data relevant to the determination of a safe condition can also be data that, for example, can be relevant to which safe condition is supposed to be adopted in a specific situation, such as when selecting multiple safe conditions or selecting a specific parameter of a safe condition from a possible parameter range.

As such, in the case of moving apparatuses or items, for example, data relevant to the determination of a safe condition can be a position and/or a speed of the apparatus or of applicable parts of the apparatus, or of the items. As such, in the case of a rollercoaster that involves looping the loop, for example, the speed and position of a specific car of the rollercoaster can be data relevant to the determining of a safe condition. As such, different safe reactions can be triggered, for example, depending on whether a specific car is midway through looping the loop or is on a flat section when a safety-relevant fault is discovered. In this way it is possible, e.g., to ensure that in the event of a corresponding emergency an applicable car is not stopped midway through looping the loop. In chemical installations, such parameter values can be, for example, measured values for specific substances and/or gases or else temperatures of specific substances or vessels. For example, a respective different safe condition can be determined based on these values, depending on precisely where specific substance measured values or temperature measured values are situated.

In principle, any measured and/or sensor value (including a sensor value from a “virtual sensor”) that is obtained when controlling an apparatus or installation can be used as a datum relevant to the determining of a safe condition.

Such data relevant to the determination of a safe condition can be established, for example, as defined by the standard IEC 61508 and, for example, can be stipulated according to this standard for the purposes of safety integrity, for example, when establishing an applicable safety-oriented system.

The application of the data relevant to the determination of a safe condition to the ML model can be established, for example, such that the data relevant to the determining of a safe condition are used as input data for the ML model. Output data of the ML model can then be, for example, data that characterize a specific safe condition. It is then possible for the method in accordance with the disclosed embodiments to established, for example, such that the applicable safe condition, such a first safe condition in according with the present disclosure, is subsequently adopted by the applicable safety-oriented system.

As already explained for the purposes of the present disclosure, such ML models can be, for example, appropriately trained neural networks, decision trees, support vector machines, sequential decision models and/or comparable ML models. The training of the applicable ML models can be established in accordance with the presently disclosed embodiments, for example.

The method in accordance with the disclosed embodiments can, for example moreover, be implemented in a manner such that the output data of the ML model are directly configured for triggering an applicable safe condition, e.g., consist of or comprise applicable control instructions.

Moreover, the output data of the ML model can also be descriptors and/or applicable idea identifiers or other characterizing data for an applicable safe condition. Here, applicable parameter values for the determined safe condition can for example subsequently be taken from a database, for example, and then the arrival at the safe condition by the safety-oriented system can be triggered.

In one advantageous embodiment, the method in accordance with the present embodiment is implemented in a manner such that a plurality of safe conditions are stored in reference to the safety-oriented control of the apparatus or installation, and the first safe condition is selected from the plurality of safe conditions via the data relevant to the determining of a safe condition being applied to the ML model.

The safety-oriented control of the apparatus or installation can, for example, in turn be effected via the execution of the safety-oriented control program.

The plurality of safe conditions can involve, for example, each of the safe conditions being configured in accordance with the presently disclosed embodiments.

The storage of a safe condition within the framework of the plurality of safe conditions can comprise, for example, an identifier or ID information of the safe condition, one or more parameters of the safety-oriented system that characterize the safe condition and/or one or more commands or instructions that trigger the adoption of the safe condition. Each of the safe conditions from the plurality of safe conditions can comprise such data.

The result of the selection of the first safe condition from the plurality of safe conditions can be or can comprise, for example, an identifier and/or ID information for this first safe condition, or can consist of or comprise specific parameters and/or instructions characterizing the first safe condition.

The plurality of safe conditions can be stored, for example, in a memory device in accordance with the presently disclosed embodiment. Such storage can be effected, for example, in a computing unit connected to a safety-oriented controller or in a safety-oriented controller itself, or the applicable memory device can be present in at least one of these devices. The plurality of safe conditions can, for example, moreover be stored within the framework of a database for safe conditions in the memory device, or in the computing unit or the safety-oriented controller.

Moreover, the method in accordance with the presently disclosed embodiments can be implement such that a succession of safe conditions is selected from the plurality of safe conditions via the data relevant to the determining of a safe condition being applied to the ML model, where the succession of safe conditions comprises the first safe condition and at least one further safe condition.

Each of the safe conditions in the succession of safe conditions can be designed and configured in accordance with the presently disclosed embodiments.

The succession of safe conditions can be configured such that following arrival at a first safe condition in the succession of safe conditions the adoption of a second safe condition in the succession of safe conditions is triggered. Accordingly, multiple or all safe conditions in the succession of safe conditions can then be adopted in succession following the triggering of the safe reaction.

The succession of safe conditions can be selected, for example, such that the triggering of the safe reaction results in as little financial loss as possible being produced.

Such a succession of safe conditions can comprise, for example, an emergency stop for an apparatus or installation, e.g., following detection of a person in a critical apparatus or installation area. Subsequently, appropriate safety measures can then be triggered in a next safe condition so as then to trigger safe restarting of the apparatus or installation with decelerated startup parameters in a further subsequent safe condition.

For example, a succession of safe conditions can also exist for the purposes of safety-oriented control of a rollercoaster that incorporates looping the loop. Here, after the occurrence of an error situation, while a car is looping the loop, a first safe condition could initially be adopted that comprises, e.g., additional locking of the handrails and possibly the triggering of a seatbelt tensioner, but with the car carrying on. Only after the car has left the loop is a second safe condition then adopted, which then, e.g., comprises an emergency stop for the car.

The method in accordance with the presently disclosed embodiments can moreover be implemented in a manner such that the first safe condition is stipulated by at least one apparatus and/or installation parameter, and the at least one apparatus and/or installation parameter comprises at least one parameter value range, and such that the application of the data relevant to the determining of a safe condition to the ML model moreover results in the determination of a parameter value or a succession of parameter values from the parameter value range.

An apparatus and/or installation parameter can be, for example, any sensor value or control parameter value that is assigned or assignable to an apparatus or installation. Sensor values can be values from sensors that are actually present or else from so-called virtual sensors. Moreover, apparatus and/or installation parameters can also be variables and operands, as are used, for example, within an applicable safety-oriented controller. Such variables or operands can be, for example, variables of a process image of a programmable logic controller or else variables or operands used for the purposes of a control program. Moreover, applicable variables can also be “tags” used for the purposes of a user interface.

The parameter value range can exist, for example, as a result of an upper and a lower limit value, just an upper limit value or merely a lower limit value, or can comprise such a parameter value range.

Moreover, a parameter value range can also comprise, for example, a number of possible single parameter values or can also consist of such a number of possible single parameter values.

In addition, the method in accordance with the presently disclosed embodiments can be implemented such that the ML model is formed and configured as a result, which is stored in a memory device, of the application of a machine learning method to ML training data.

The ML training data can be configured for training the ML model in accordance with the presently disclosed embodiments. The application of the machine learning method to the ML training data can also be configured in accordance with the presently disclosed embodiments.

It is also an object of the invention to provide a safety-oriented control device for the safety-oriented control of an apparatus or installation via the execution of a safety-oriented control program, where the safety-oriented control device is configured for performing the method in accordance with the presently disclosed embodiments.

The aforementioned safety-oriented control device achieves the aforementioned object because the safety-oriented control device has mechanisms implemented in it that produce a method for ascertaining and/or selecting a safe condition.

The safety-oriented control device, the apparatus or installation and the safety-oriented control program can be configured in accordance with the presently disclosed embodiments.

Such a safety-oriented control device can moreover be configured such that the safety-oriented control device comprises the memory device having the ML model, or such that the safety-oriented control device is communicatively coupled to the memory device having the ML model.

The safety-oriented control device, the memory device and/or the ML model can be configured in accordance with the presently disclosed embodiments.

The circumstance that the control device is communicatively coupled to the memory device comprising the ML model can be configured, for example, such that the control device and the memory device are communicatively linked inside a device, or such that the control device and the memory devices are located in different devices that are connected, by wire or else wirelessly, via an appropriate data connection.

In addition, the safety-oriented control device in accordance with the disclosed embodiments can be configured such that the safety-oriented control device is formed and configured as a modular safety-oriented control device having a safety-oriented central module, and such that the safety-oriented central module comprises the memory device having the ML model.

The safety-oriented central module can be configured for the execution of the safety-oriented control program, for example. In particular, the central module can be configured in compliance with the guidelines for functional safety according to the standard IEC 61508, in particular can be certified according to this standard, or comparable standards.

The circumstance that the safety-oriented central module comprises the memory device having the ML model can be configured, for example, such that the safety-oriented central module comprises the memory device comprising the ML model.

In one advantageous embodiment, the safety-oriented control device can moreover be configured such that the safety-oriented control device is formed and configured as a modular safety-oriented control device having a safety-oriented central module and a KI module, such that the safety-oriented central module and the KI module are communicatively coupled via a backplane bus of the safety-oriented control device, and such that the KI module comprises the memory device having the ML model.

A backplane bus is understood to mean a data connection system of a modular programmable logic controller that is configured for communication between different modules of the modular programmable logic controller. The backplane bus can comprise, for example, a physical bus component that is configured for transmitting information between different modules of the programmable logic controller. The backplane bus can also be configured such that it is set up only during the installation of different modules of the programmable logic controller (e.g., is set up as a “daisy chain”).

The applicable control device can then be configured, for example, such that the triggering of a safe reaction results in the data relevant to the determining of a safe condition being transmitted from the central module via the backplane bus to the KI module, being supplied there to the ML model and then the data that are output by the ML model in reference to the first safe condition being transmitted back to the central module again. There, the necessary mechanisms that lead to the first safe condition being adopted can then be triggered subsequently, for example.

The programmable logic controller, the memory device and the ML model can moreover be configured in accordance with the presently disclosed embodiments.

It is an advantage of this embodiment of the invention that the safety-oriented control device can be flexibly adapted for different systems requiring different kinds of ML models, for example, by using a KI module. Moreover, this also allows a better-trained ML model to be implemented in a new KI module, which then replaces an older KI module. This provides a very simple way of improving the selection of a safe condition more and more.

In addition, the safety-oriented control device can be configured such that the KI module is in the form of and configured as a safety-oriented KI module. In this advantageous embodiment, the KI module can be configured, or certified, in compliance with the standard IEC 61508 or comparable standards for functional safety, for example. In this way, the combination of KI module and central processing unit is completely accessible to a safety-oriented controller. Moreover, there can also be provision for the combination of central module and KI module to be certified according to a standard for functional safety, e.g., IEC 61508, or to be configured according to this standard.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in more detail by way of illustration with reference to the accompanying figures, in which:

FIG. 1 shows an example of a safety-oriented controller that controls an applicable installation;

FIG. 2 shows a schematic depiction of an illustrative sequence for the selection of a safe condition using an ML model;

FIG. 3 is a flow chart of the method in accordance with the invention

### DETAILED DESCRIPTION OF THE EXEMPLARY EMBODIMENTS

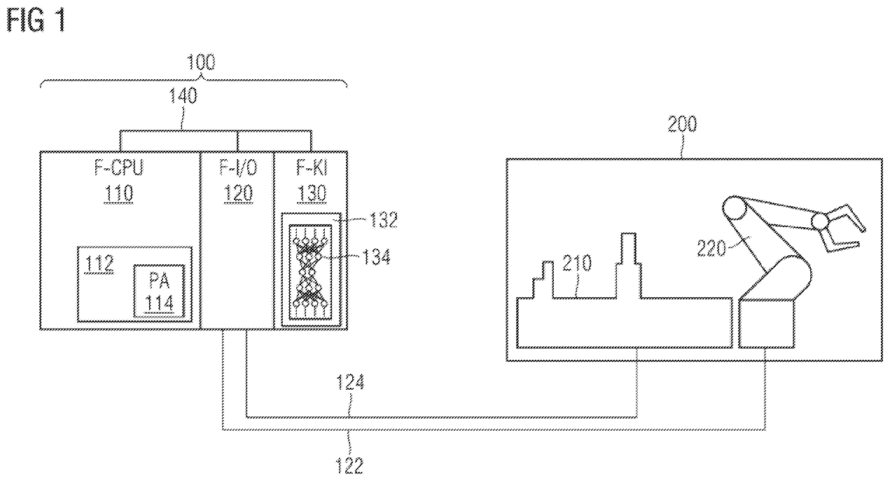

FIG. 1 shows a safety-oriented modular control device 100, also referred to within the present disclosure as modular PLC 100. The modular PLC 100 comprises a safety-oriented central processing unit 110 having a memory device 112. A process image 114 of the central processing unit 110 is stored inside the memory device 112.

The central processing unit 110 is configured to execute a safety-oriented control program and formed and configured as a safety-oriented central processing unit 110 according to the standard IEC 61508. A backplane bus 140 connects the central processing unit 110 to an input/output module 120, which is likewise formed and configured as a safety-oriented input/output module 120. The process image 114 stores input and output values of the safety-oriented control program.

Moreover, the backplane bus 140 connects a KI module 130 to the central processing unit 110 and to the input/output module 120. The KI module 130 is likewise formed and configured as a safety-oriented KI module 130. The KI module 130 comprises a memory device 132 having a trained neural network 134 and is an example of a KI module in accordance with the present invention. The neural network 134 is an example of an ML model in accordance the present invention. The neural network 134 has been trained, for example, using a method and data as were disclosed in accordance with the exemplary embodiments.

Moreover, FIG. 1 depicts an installation 200 that comprises a transport device 210 and a robot 220. The modular PLC 100 is configured for the safety-oriented control of this installation 200. To this end, for example, the input/output module 120 is connected to the transport module 210 of the installation 200 via a first data line 124, or first field bus line 124. Moreover, a second data line 122, or second field bus line 122, connects the input/output module 122 to the robot 220 of the installation 200. The field bus lines 122, 124 are used to transmit control signals from the modular PLC 100 to the components 210, 220 of the installation 200 and applicable sensor or device data from the installation 200 back to the modular PLC 100.

The safety-oriented control of the installation 200 by the modular PLC 100 involves a cyclic execution of the safety-oriented control program that executes in the central processing unit 110 of the modular PLC 100 resulting in data of the process image 114 being read in at the beginning of a program cycle. These data are processed during the execution of the program cycle, and the results determined in the process are then stored in the process image 114, again as current control data. These current control data are then transmitted to the installation 200 via the backplane bus 140 and the input/output module 120 and also the field bus lines 124, 122. Applicable sensor data or other data of the installation 200 are transmitted back to the modular PLC 100 and the process image 114 in the central processing unit 110, again on the same path.

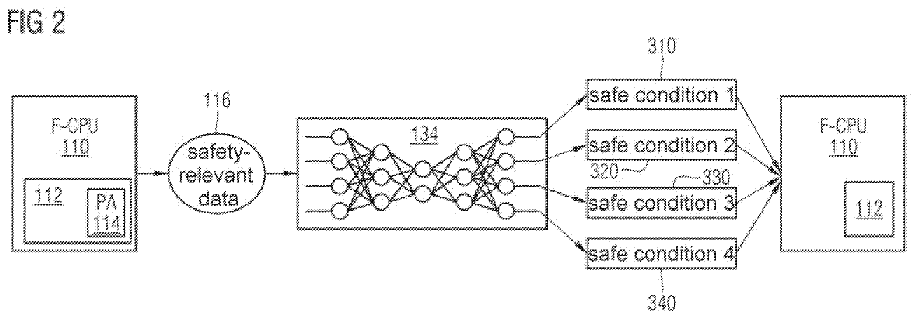

FIG. 2 shows an illustrative schematic sequence for the case in which the safety-oriented control of the installation 200 results in a safe reaction being triggered.

In this regard, the memory device 112 of the central processing unit 110 of the modular PLC 100 stores respective parameters for the installation 200 in reference to four safe conditions 310, 320, 330, 340. The parameters of the respective safe condition 310, 320, 330, 340 are used to explicitly define the applicable safe condition 310, 320, 330, 340 of the installation 200. The control program of the modular PLC 100 is configured such that handover of the applicable parameters of one of the safe conditions 310, 320, 330, 340 is immediately followed by triggering of the adoption of the applicable safe condition 310, 320, 330, 340 by the installation 200.

FIG. 2 schematically shows the central processing unit 110 with the memory device 112 and the process image 114 in the block on the far left. The triggering of the safe reaction now results in predefined data from the process image, as data 116 relevant to the determining of a safe condition, being transmitted via the backplane bus 140 from the central processing unit 110 to the KI module 130 and handed over there as input data to the trained neural network 134 that is stored there.

The trained neural network 134 is configured such that it has four (or more) outputs, where each of the outputs is assigned one of the safe conditions 310, 320, 330, 340. After the relevant data 116 are input into the neural network 134, one of the safe conditions 310, 320, 330, 340 is then output by the neural network and the information about this determined safe condition 310, 320, 330, 340, which corresponds to a first safe condition in accordance with the present invention, is transmitted back to the central processing unit 110 again via the backplane bus 140.

The parameters assigned to this selected safe condition 310, 320, 330, 340 are now read from the memory device 112 in the central processing unit 110 and routed to the safety-oriented control program such that there is immediate triggering of the adoption of the selected safe condition 310, 320, 330, 340 by the installation 200. Applicable control signals are then transmitted to the transport device 210 and the robot 220 of the installation 200 via the field bus lines 124, 122.

The present invention describes a method for selecting a safe condition for the purposes of safety-oriented control of an apparatus or installation, the safe condition being selected by using an ML model. This allows suitable safe conditions (in particular safe conditions that entail as little financial loss as possible) to be adopted for each specific situation in a simplified manner even for more complex machines, apparatuses or installations.

It is of no importance to the fact that a safety-oriented controller is involved that the results of an ML model are possibly not immediately logically comprehensible to a user. The only relevance to the fact that control is safety-oriented is that the triggering of a safe reaction results in a safe condition being adopted in any event. This is also always the case for the presently disclosed embodiments of the method kin accordance with the invention.

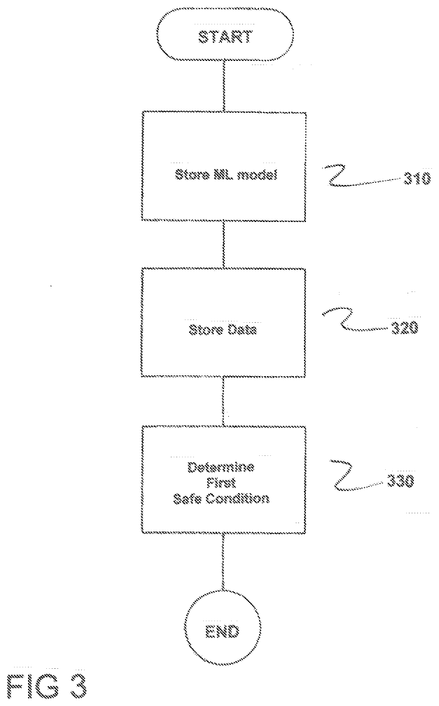

FIG. 3 is a flowchart of the method for determining a safe condition by utilizing a safety-oriented control device 100 that is configured for safety-oriented control of an apparatus or installation 200 via execution of a safety-oriented control program which, when executed, results in a safe reaction being triggered in the safety-oriented controller 100.

The method comprises storing an ML model 134 in a memory device 112, 132 of an application of a machine learning method, the ML model 134 being configured as and forming a result, as indicated in step 310.

Next, data 116 relevant to the determining the safe condition in connection with the triggering of the safe reaction is stored, as indicated in step 320.

Next, a first safe condition 310, 320, 330, 340 is determined via the data 116 relevant to the determining of the safe condition being applied to the ML model 134, as indicated in step 330.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for determining a safe condition by utilizing a safety-oriented control device which is configured for safety-oriented control of an apparatus or installation via execution of a safety-oriented control program which, when executed, results in a safe reaction being triggered in the safety-oriented controller, the method comprising:
storing an ML model in a memory device of an application of a machine learning method, the ML model being configured as and forming a result;
storing data relevant to the determining the safe condition in connection with the triggering of the safe reaction; and
determining a first safe condition via the data relevant to the determining of the safe condition being applied to the ML model.

2. The method as claimed in claim 1, wherein a plurality of safe conditions are stored in reference to the safety-oriented control of the apparatus or installation; and
wherein the first safe condition is selected from the plurality of safe conditions via the data relevant to the determining of the safe condition being applied to the ML model.

3. The method as claimed in claim 2, wherein a succession of safe conditions is selected from the plurality of safe conditions via the data relevant to the determining of the safe condition being applied to the ML model;
wherein the succession of safe conditions comprises the first safe condition and at least one further safe condition.

4. The method as claimed in claim 1, wherein the first safe condition is stipulated by at least one apparatus and/or installation parameter, and said at least one apparatus and/or installation parameter comprises at least one parameter value range; and
wherein the application of the data relevant to the determining of the safe condition to the ML model further results in determination of a parameter value or a succession of parameter values from the parameter value range.

5. The method as claimed in claim 1, wherein the ML model is formed and configured as a result, which is stored in the memory device, of the application of the machine learning method to ML training data.

6. A safety-oriented control device for safety-oriented control of an apparatus or installation via the execution of a safety-oriented control program, comprising:
a processor; and
wherein the processor is configured to:
store an ML model in a memory device of an application of a machine learning method, the ML model being configured as and forming a result;
store data relevant to the determining the safe condition in connection with the triggering of the safe reaction; and
determine a first safe condition via the data relevant to the determining of the safe condition being applied to the ML model.

7. The safety-oriented control device as claimed in claim 6, wherein one of:
(i) the safety-oriented control device further comprises the memory device having the ML model and
(ii) the safety-oriented control device is communicatively coupled to the memory device having the ML model.

8. The safety-oriented control device as claimed in claim 6, wherein the safety-oriented control device is formed and configured as a modular safety-oriented control device having a safety-oriented central module; and wherein the safety-oriented central module comprises the memory device having the ML model.

9. The safety-oriented control device as claimed in claim 7, wherein the safety-oriented control device is formed and configured as a modular safety-oriented control device having a safety-oriented central module; and wherein the safety-oriented central module comprises the memory device having the ML model.

10. The safety-oriented control device as claimed in claim 6, wherein the safety-oriented control device is formed and configured as a modular safety-oriented control device having a safety-oriented central module and a KI module;
wherein the safety-oriented central module and the KI module are communicatively coupled via a backplane bus of the safety-oriented control device; and
wherein the KI module comprises the memory device having the ML model.

11. The safety-oriented control device as claimed in claim 7, wherein the safety-oriented control device is formed and configured as a modular safety-oriented control device having a safety-oriented central module and a KI module;
wherein the safety-oriented central module and the KI module are communicatively coupled via a backplane bus of the safety-oriented control device; and
wherein the KI module comprises the memory device having the ML model.

12. The safety-oriented control device as claimed in claim 10, wherein the KI module is formed and configured as a safety-oriented KI module.
